(19) United States
(12) Patent Application Publication
(10) Pub. No.: US 2007/0089709 A1
(43) Pub. Date: Apr. 26, 2007

(54) Method and device for operating an internal combustion engine

(76) Inventors: Dirk Hartmann, Stuttgart (DE); Werner Mezger, Eberstadt (DE); Oliver Krannich, Tamm (DE); Ingo Fecht, Ludwigsburg (DE)

Correspondence Address: KENYON & KENYON LLP, ONE BROADWAY, NEW YORK, NY, 10004, US

(21) Appl. No.: 11/581,818

(22) Filed: Oct. 16, 2006

(30) Foreign Application Priority Data
Oct. 18, 2005 (DE) 10 2005 049 777.2

(51) Int. Cl. F02B 15/00; F01L 1/34

(52) U.S. Cl. 123/432; 123/90.16

(57) ABSTRACT

A method and a device for operating an internal combustion engine, which make possible a defined and reliable cutting in or cutting off a gas-exchange valve of a cylinder. In at least one operating state, at least one intake valve or exhaust valve of a cylinder is cut off or at least one cut-off intake valve or exhaust valve of the cylinder is cut in again, the at least one intake valve or exhaust valve being opened and/or closed using an operating element; and the operating element being switched off or switched on again using a coupling element. A response delay time is ascertained which is required for the operation of the coupling element for the switching off or switching on again the operating element. Furthermore, a switching time window is ascertained within which the operation of the coupling element is desired. Moreover, it is checked whether the switching time window is greater than the response delay time. In this case, a beginning of the switching procedure for cutting off or cutting in again the at least one intake valve or exhaust valve is established in such a way that the response delay time lies completely within the switching time window.

### FIELD OF THE INVENTION

The present invention relates to a method and a device for operating an internal combustion engine.

### BACKGROUND INFORMATION

Conventional methods and devices for operating an internal combustion engine include at least one operating state in which at least one intake valve or exhaust valve of a cylinder is cut off or at least one cut-off intake valve or exhaust valve of the cylinder is cut in again. The at least one intake valve or exhaust valve is opened and/or closed using an operating element, and the operating element is disconnected or connected again using a coupling element.

### SUMMARY

Example methods and devices according to the present invention for operating an internal combustion engine may have the advantage that a response delay time is ascertained that is required for operating the coupling element during disconnecting or reconnecting the operating element, a switching time window is ascertained within which the operation of the coupling element is desired, that it is checked whether the switching time window is greater than the delay time, and, in this case, a beginning of the switching procedure for cutting off or cutting in again the at least one intake valve or exhaust valve is established in such a way that the delay time lies completely within the switching time window. It may be ensured in this way that the operation of the coupling element does not start before the beginning of the switching time window and does not end after the end of the switching time window. This may make it possible to avoid faulty connections of the coupling element, which are able to lead to potential damage of the connecting mechanism, especially of the coupling element and of the operating element, or of the at least one intake valve or exhaust valve, in response to a suitable selection of the switching time window.

It is particularly advantageous if it is checked whether the switching time window is greater than or equal to the delay time, including at least one safety time interval, and if the beginning of the switching procedure is established in such a way that a first specified safety time interval between the response delay time and the beginning of the switching time window and/or a second specified safety time interval between the delay time and the end of the switching time window are maintained. In this way, a tolerance range may be set up between at least one border of the switching time window and the response delay time, so that the operation of the coupling element is able to take place at a sufficient distance from at least one of the switching time window borders. This may make it possible to avoid faulty operations of the coupling element, which are able to lead to potential damage of the coupling element, of the operating element, and/or of the at least one intake valve or exhaust valve. Also, a maximum rotary speed limit, in which the at least one intake valve or exhaust valve can still be cut off or cut in again without damage to the coupling element, the operating element and/or the at least one intake valve or exhaust valve, is able to be increased, since this maximum rotary speed limit is determined by a suitably selected position of the response delay time within the switching time window, that is, having appropriate safety time intervals from the borders of the switching time window.

It may be advantageous if the first specified safety interval and the second specified safety time interval are selected to be of the same size. In this way, one may avoid to the greatest extent having to use protection from damage to the coupling element, the operating element and/or the at least one intake valve or exhaust valve during the operation of the coupling element, and maximize the maximum rotary speed limit for the cutting off or cutting in again the at least one intake valve or exhaust valve. The response delay time for operating the coupling element then lies centrically in the switching time window, so that the required securities with respect to the tolerances are uniformly distributed to the borders of the switching time window.

It may also be advantageous if a time delay time is ascertained which corresponds to the time duration from the beginning of an electrical control of the switching procedure to the point in time of the setting in of the operation of the coupling element, and if the beginning of the switching procedure is established by the time delay before the beginning of the response delay time. In this way, the time delay time required for the operation of the coupling element is also taken into consideration, and with that, it is ensured that the operation of the coupling element can actually take place in the range of the response delay time provided for it within the switching time window.

It may also be advantageous if the switching time window is ascertained in such a way that it begins at the opening of the at least one intake valve or exhaust valve and ends at the next opening of the at least one intake valve or exhaust valve. In this way it may be avoided that the intake valve or exhaust valve is damaged because of the operation of the coupling element or remains stuck in the open position. This occurs especially if variable control times are provided for the opening of the at least one intake valve or exhaust valve.

It may also be advantageous if the operating element of at least one intake valve and the operating element of at least one exhaust valve are cut off or cut in again by a common coupling element, and if the switching time window is ascertained in such a way that it begins after the opening of both the at least one intake valve and the at least one exhaust valve, and that it ends before the next opening both of the at least one intake valve and the at least one exhaust valve. In this manner, even in the case of the use of such a common coupling element, it may be avoided that, in response to an operation of the common coupling element, the at least one intake valve or the at least one exhaust valve are damaged or get stuck in an open position.

### BRIEF DESCRIPTION OF THE DRAWINGS

An exemplary embodiment of the present invention is shown in the drawings and explained in greater detail below.

FIG. 1 shows a block diagram of a device for cutting off or cutting in again an intake valve or exhaust valve of a cylinder of an internal combustion engine.

FIG. 2 shows a functional diagram for illustrating an example device and method according to the present invention.

FIG. 3 shows a time line for illustrating the establishment of a control time for cutting off or cutting in again the at least one intake valve or exhaust valve.

FIG. 4 shows a first example for establishing a switching time window.

FIG. 5 shows a second example for establishing a switching time window.

FIG. 6 shows a third example for establishing a switching time window.

FIG. 7 shows an operating element for opening and closing the at least one intake valve or exhaust valve including the coupling element for cutting off and cutting in again the operating element.

FIG. 8a shows the operating element with the cut-in intake valve or exhaust valve.

FIG. 8b shows the operating element with the cut-off intake valve or exhaust valve.

### DETAILED DESCRIPTION OF EXAMPLE EMBODIMENTS

The present invention includes methods and devices for operating an internal combustion engine such as an Otto engine or a Diesel engine. In at least one operating state of the internal combustion engine, in this context, at least one intake valve or exhaust valve 1 of a cylinder of the internal combustion engine is cut off or at least one cut-off intake valve or exhaust valve 1 of the cylinder is cut in again. Thus, for instance, a first operating state of the internal combustion engine may be provided in which half the cylinders are cut off by cutting off the intake valves or exhaust valves as well as the fuel injection. This first operating state is also designated as half engine operation. It can be set by bank cutoff or by cylinder cutoff. In the case of bank cutoff, the internal combustion engine includes an even number of cylinder banks, of which one-half are cut off for all cylinders in the manner described, that is, by cutting off the intake valves or exhaust valves as well as the fuel injection. In the case of cylinder cutoff, in response to half engine operation, half of the cylinders are cut off by cutting off the intake valves or exhaust valves as well as the fuel injection, and independently of on which cylinder bank the cylinders are located and also independently of how many cylinder banks the internal combustion engine has to begin with. In this context it has proven advantageous in the case of half engine operation to cut off every other cylinder in the firing order in order to ensure as quiet an engine operation as possible. In a second operating state of the internal combustion engine, for example, all cylinders are cut in again, that is, their intake valves and exhaust valves as well as the fuel injection are cut in again. The second operating state is also designated as full engine operation. Because of the bank cutoff or the cylinder cutoff, the half engine operation makes possible a fuel saving compared to the full engine operation.

The time at which a deactivation or an activation can take place, that is, a cutoff or cut-in again of an intake valve or exhaust valve designated also as gas-exchange valve, is limited by the base circle of the camshaft, since only then the gas-exchange valve in question is in a powerless rest state and is closed.

The half engine operation is possible in a restricted operating range of the internal combustion engine with respect to the engine torque and the engine's rotary speed. Thus, for the half engine operation, there is an upper boundary Md1 for the possible engine torque as well as a lower boundary nmot1 and an upper boundary nmot2 of the engine speed. For engine torques Md<Md1 and for engine speeds nmot1<nmot<nmot2, the half engine operation is possible, and in other cases the internal combustion engine is operated in full engine operation, in this example. Starting from full engine operation, if the operating range of the half engine operation is achieved, one-half the cylinders of the internal combustion engine are cut off in the manner described above, by bank cutoff or cylinder cutoff by the corresponding cutoff of the intake valves or exhaust valves as well as the fuel injection. Starting from the half engine operation, if the operating range of the full engine operation is achieved, the cut off cylinders are cut in again by cutting in again the intake valves or exhaust valves as well as the fuel injection.

The crankshaft angle at which the gas-exchange valves open and close is able to be changed by a camshaft adjustment. In this context, a separate camshaft and a separate adjustment of these camshafts may be provided respectively for each intake valve or exhaust valve.

A response delay appears between the electrical output of a switching signal for cutting off a gas-exchange valve or for cutting back in a cut-off gas-exchange valve and the resulting mechanical switchover of the gas-exchange valve.

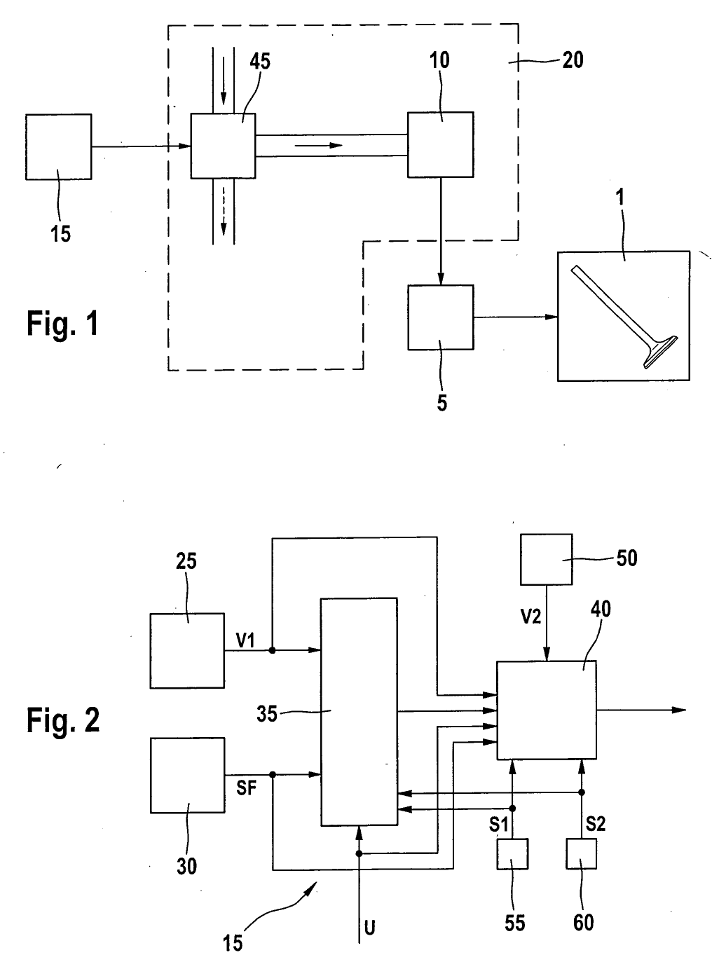

FIG. 1 schematically shows in the form of a block diagram a device for cutting off or cutting in again a gas-exchange valve. The gas-exchange valve, which may be, for instance, an intake valve or an exhaust valve of a cylinder of the internal combustion engine, is shown in FIG. 1 as reference numeral 1. The gas-exchange valve is operated by an operating element 5, namely, it is either opened or closed. A switching unit 20 is also provided, which switches off or switches on again operating element 5, and therewith also gas-exchange valve 1. To do this, switching unit 20 includes, for example, a coupling element 10 which, in the case of cutting off gas-exchange valve 1, decouples operating element 5 from gas-exchange valve 1, and in the case of cutting in again gas-exchange valve 1, couples operating element 5 to gas-exchange valve again. Switching unit 20 also includes, in this example, a three-way valve 45, which applies oil pressure to coupling element 10 that is required for the switching off or switching on again of operating element 5. Switching unit 20 and three-way valve 45 in it are controlled electrically by a control unit 15, which is, for instance, implemented in a control device in a software and/or hardware manner.

Instead of controlling the coupling element 10 using oil pressure or, more generally, fluid pressure, it is also possible to control the coupling element 10 using air pressure or, more generally, gas pressure or magnetic or piezoelectric control of coupling element 10, or the like.

In this example, the coupling element 10 is controlled using oil pressure.

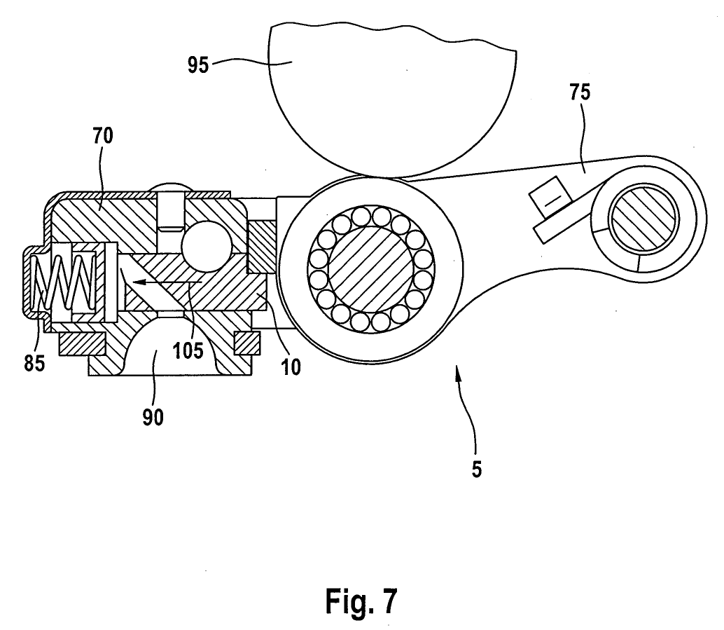

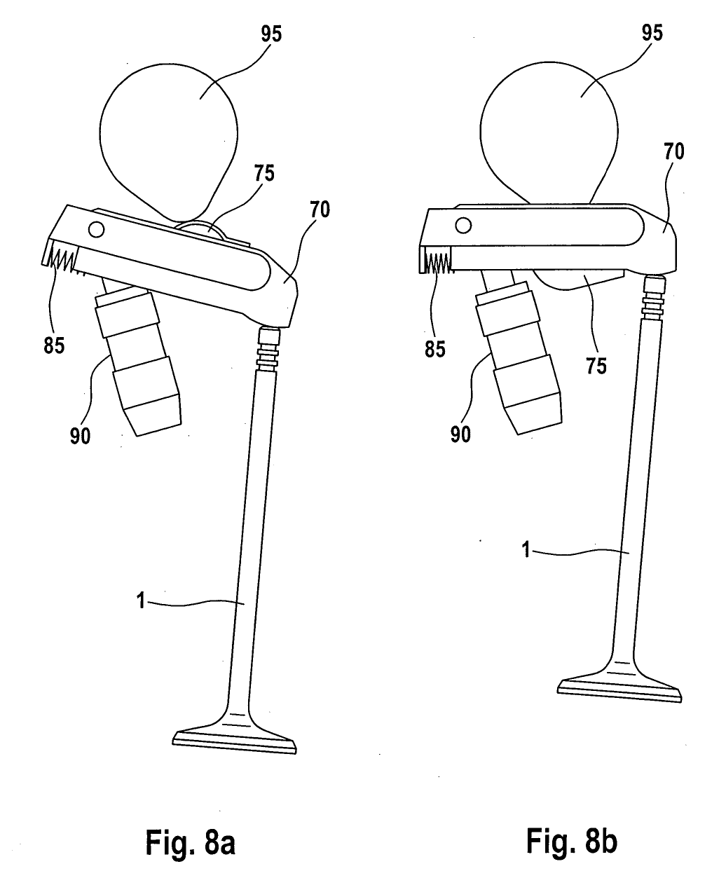

FIG. 7 shows an exemplary embodiment of operating element 5 in the form of a two-part lever element. A camshaft 95 acts on a second part 75 of operating element 5. Second part 75 is connected to a first part 70 of operating element 5 via coupling element 10, which is designed as a stud in this example, gas-exchange valve 1 being coupled to first part 70. If first part 70 and second part 75 of operating element 5 are coupled via stud 10, then a motion of second part 75, caused by camshaft 95, leads to a corresponding motion of first part 70, and therewith a motion of gas-exchange valve 1 for opening or closing the assigned opening of the combustion chamber of the assigned cylinder. This situation is also shown in FIG. 8a, in which the same reference numerals designate the same elements as in FIG. 7, and in which first part 70 and second part 75 of operating element 5 are coupled to each other. In this context, stud 10 is in its resting position, as it is present, for example, in the full engine operating state described here. This resting position of stud 10 is ensured by the restoring force of a resetting spring 85. As may be seen in FIG. 8a, resetting spring 85 is less compressed, in this instance, than in FIG. 8b described below. First part 70 includes a store 90 having an oil pressure supply. In response to sufficient oil pressure in store 90, as, for instance, in half engine operation, stud 10 rides against the restoring force of spring 85, and to the left, as shown by arrow 105, so that first part 70 and second part 75 are decoupled. In this case, the operation of second part 75 by camshaft 95 no longer leads to an operation of first part 70, and thus no longer to an operation of gas-exchange valve 1, which in this case is cut off. Only when the oil pressure in store 90 becomes lower again is stud 10 pressed towards the right again, based on the restoring force of resetting spring 85, in order to bring first part 70 and second part 75 into a coupled position again, and thereby to cut in again gas-exchange valve 1. The decoupling of first part 70 and second part 75, and the coupling again of first part 70 and second part 75 using stud 10 is only possible, in this context, if camshaft 95 presses against second part 75 using its base circle. In FIG. 8b, first part 70 and second part 75 are decoupled so that the operation of second part 75 by camshaft 95 no longer leads to an operation of gas-exchange valve 1. In FIG. 8b, it may be seen, in this instance, that resetting spring 85 is displaced less, because of the motion of stud 10 towards the left, than in FIG. 8a.

In FIG. 8b too, the same reference numerals designate the same elements as in FIGS. 7 and 8a. The operation of stud 10 for decoupling first part 70 and second part 75 or for coupling again first part 70 and second part 75 takes place with a response delay based on the moment of inertia. In this context, the forces that act on stud 10, and thus, the response delay of the decoupling of first part 70 and second part 75 by the motion of stud 10 to the left (oil pressure greater than spring force) and of the recoupling of first part 70 and second part 75 by the motion of stud 10 to the right (spring force greater than oil pressure) may be different.

FIG. 2 shows a functional diagram of control unit 15, which may be implemented, for instance, in an engine control unit in the form of software or hardware. Control unit 15 includes a response time delay ascertainment unit 25 which ascertains the delay, or rather the delay time linked with it in the operation of stud 10, in the case of the decoupling of first part 70 and second part 75 and in the case of recoupling first part 70 and second part 75, at current conditions. This data input of the times may, for example, be made all at one time on a test stand. In this context, then, a first response delay time is ascertained for the motion of stud 10 to the left for decoupling first part 70 and second part 75, and is stored in unit 25. Furthermore, a second response delay time is ascertained for the motion of stud 10 to the right for recoupling first part 70 and second part 75, and is stored in unit 25. The different response delay times during decoupling and coupling again first part 70 and second part 75 originate from the fact that, during decoupling, resetting spring 85 is pressed together with the aid of the oil pressure, and during recoupling, resetting spring 85 extends again, based on the abating oil pressure. The two procedures, in this instance, are described by different forces, and are thus characterized by different response delay times.

In addition, control unit 15 includes a switching time window ascertainment unit 30, which ascertains a switching time window as a function of the current control times of the gas-exchange valves, within which the operation of the coupling element, in this example stud 10, is desirable and possible. The ascertainment of the switching time window is described below, in the light of FIGS. 4, 5 and 6.

Control unit 15 also includes a test unit 35 which retrieves the first response delay time from response delay ascertainment unit 25 if a gas-exchange valve 1 is to be cut off, and which retrieves the second response delay from response delay ascertainment unit 25 if a gas-exchange valve 1 is to be cut in again. Furthermore, test unit 35 retrieves from switching time window ascertainment unit 30 the currently ascertained switching time window. Test unit 35 tests whether the current switching time window is greater than the response delay time currently retrieved from response delay time ascertainment unit 25. If this is the case, an output of test unit 35 is set, and the set pulse thus generated is conveyed to a specification unit 40, which also has supplied to it the response delay time of response delay time ascertainment unit 25 retrieved from test unit 35, and the current switching time window of switching time window ascertainment unit 30 retrieved by test unit 35. A first specified safety time interval S1 from a first safety time interval memory 55, and a second specified safety time interval S2 from a second safety time interval memory 60, are also supplied to specification unit 40. The response delay time is shown in FIG. 2 by V1 and the switching time window is shown by SF. A time delay time V2 is also supplied to specification unit 40 by a time delay time ascertainment unit 50. Time delay time V2, in this context, characterizes the time duration of the beginning of an electrical control of the switching procedure by control unit 15 to the time the operation of coupling element 10 sets in.

In the present example of coupling element 10 developed as a stud controlled by oil pressure, time delay time corresponds to the time duration from the beginning of the electrical control of the switching procedure by control unit 15 to a time at which the oil pressure in store 90 is so great that stud 10 begins moving to the left. Response delay time V1 then corresponds to the time stud 10 requires so as to be moved from its resting position according to FIG. 7 so far to the left that first part 70 is decoupled from second part 75, and gas-exchange valve 1 has thus been cut off. This applies for the procedure of cutting off gas-exchange valve 1. For the procedure of cutting in again a cut off gas-exchange valve 1, in the present example, time delay time V2 represents the time duration from the beginning of the electrical control of the switching procedure on the part of control unit 15 to a time at which the oil pressure in store 90 has been reduced so far that stud 10 moves again to the right, due to the decoupled state of first part 70 and second part 75. Response delay time V1 is then that time which lasts from the beginning of the motion of stud 10 to the right until the time at which first part 70 and second part 75 are coupled to each other and stud 10 has reached its resting position again. The response delay times for the decoupling and the recoupling of the two parts 70, 75 of operating element 5 are able to differ as described, and are ascertained as described on a test stand, for example, and stored, as described, in response delay time ascertainment unit 25. The time delay time for cutting off gas-exchange valve 1 and the time delay time for cutting in again gas-exchange valve 1 are also able to differ from each other, and are also able to be ascertained on a test stand and stored in time delay time ascertainment unit 50. Based on aging and wear of stud 10 it may optionally be of advantage to relearn response delay times V1 at regular or irregular intervals and to update them appropriately in response delay time ascertainment unit 25. The corresponding applies to time delay times V2, in which, for instance, aging and wear of the oil pressure supply and three-way valve 45 become noticeable, and should thus also be relearned at regular or irregular time intervals, and be updated in time delay time ascertainment unit 50, in order to ensure a fault-free operation of the cutoff and cut-in again of the corresponding gas-exchange valve 1.

In the case of receiving a set pulse from test unit 35, specification unit 40 now determines the point in time for the beginning of the switching procedure for cutting off or cutting in again gas-exchange valve 1, so that response delay time V1 linked to the cutoff or the cut-in again lies completely within the switching time window. The testing described, by test unit 35, is carried out only if test unit 35 receives a switchover request signal U from the engine control. Switchover signal U indicates in this example whether switchover is to proceed from half engine operation to full engine operation or from full engine operation to half engine operation. If switchover request signal U indicates that switching is to proceed from full engine operation to half engine operation, test unit 35 reads out from response delay time ascertainment unit 25 delay time V1 for the case of the decoupling of first part 70 and second part 75. If switchover request signal U indicates that switching is to proceed from half engine operation to full engine operation, test unit 35 reads out from response delay time ascertainment unit 25 that delay time V1 which is linked to the recoupling of first part 70 and second part 75 of operating element 5. Switchover request signal U is also supplied to specification unit 40. If switchover request signal U specifies a switchover from full engine operation to half engine operation, specification unit 40 reads out from response delay time ascertainment unit 25 that delay time V1 which is linked to the decoupling of first part 70 and second part 75. In addition, specification unit 40 in this case reads out from time delay time ascertainment unit 50 that time delay time V2 which is linked to the decoupling of first part 70 and second part 75 of operating element 5. In the case where switchover request signal U indicates a switchover from half engine operation to full engine operation, specification unit 40 reads out from response delay time ascertainment unit 25 that delay time V1 which is linked to the recoupling of first part 70 and second part 75. In addition, specification unit 40 in this case reads out from time delay time ascertainment unit 50 that time delay time V2 which is linked to the recoupling of first part 70 and second part 75 of operating element 5.

In the case where specification unit 40 receives both switchover request signal U and the set pulse of test unit 35, it outputs a control signal for controlling three-way valve 45, at the ascertained point in time for the beginning of the switching procedure. In the case where switchover request signal U requests a switchover from full engine operation to half engine operation, three-way valve 45 is controlled by specification unit 40 in such a way that the oil pressure at coupling element 10, in this example at stud 10, is increased for the decoupling of first part 70 and second part 75. In the case where switchover request signal U requests a switchover from half engine operation to full engine operation, the control of three-way valve 45 takes place in such a way that the oil pressure at stud 10 is reduced again for the recoupling of first part 70 and second part 75 of operating element 5.

For the case in which specification unit 40 receives the set pulse from test unit 35 during the reception of switchover request signal U, the control of three-way valve 45 takes place as described. In the case in which specification unit 40 does not receive a set pulse from test unit 35 during the reception of switchover request signal U, there is also no change in the control of three-way valve 45, so that the current state of gas-exchange valve 1 is maintained, that is, a cut off gas-exchange valve 1 continues to be cut off and a cut-in gas-exchange valve 1 continues to be cut in, that is, the control of three-way valve 45 so as to make available the required oil pressure at stud 10 remains unchanged.

The use of first specified safety time interval S1 and second specified safety time interval S2 is optional. In this context, first specified safety time interval S1 and second specified safety time interval S2 are supplied both to specification unit 40 and test unit 35.

In the exemplary embodiment described above, response delay time V1 currently retrieved from test unit 35 is less than currently ascertained switching time window SF, and specification unit 40 establishes the point in time of the beginning of the switching procedure and therewith the point in time of the beginning of the corresponding control of three-way valve 45 in such a way that currently retrieved delay time V1 lies completely within currently ascertained switching time window SF.

It may optionally be provided that test unit 35 not only tests whether the switching time window is greater than delay time V1 read out currently from response delay time ascertainment unit 25, but also whether the switching time window is greater than this delay time V1, inclusive of at least one of the two safety time interval S1, S2. The set pulse is emitted only in this case by the test unit to specification unit 40. Thus, for instance, test unit 35 is able to test whether the switching time window is greater than currently read-in response delay time V1 inclusive of first specified safety time interval S1. If this is the case, test unit 35 outputs a set pulse, and otherwise it does not. In the case of the received set pulse, specification unit 40 establishes the point in time of the beginning of the switching procedure in such a way that first specified safety time interval S1 between the beginning of the switching time window and currently used delay time V1 is maintained, and currently used response delay time V1 nevertheless lies completely within the switching time window. Alternatively, test unit 35 tests whether the currently ascertained switching time window is greater than currently ascertained response delay time V1 inclusive of second specified safety time interval S2 between currently ascertained delay time V1 and the end of currently ascertained switching time window SF. In this case, test unit outputs a set pulse to specification unit 40, and otherwise it does not. If specification unit 40 receives the set pulse, it establishes the point in time of the beginning of the switching procedure in such a way that second specified safety time interval S2 between currently ascertained response delay time V1 and the end of currently ascertained switching time window SF is maintained, and currently ascertained delay time V1 lies completely within currently ascertained switching time window SF.

Alternatively, test unit 35 tests whether currently ascertained switching time window SF is greater than the currently ascertained response delay, inclusive of both first specified safety time interval S1 and second safety time interval S2. If this is the case, test unit 35 outputs a set pulse to specification unit 40, and otherwise it does not. When specification unit 40 receives the set pulse, it establishes the point in time of the beginning of the switching procedure in such a way that the first specified safety time interval S1 between currently ascertained response delay time V1 and the beginning of currently ascertained switching time window SF and second safety time interval S2 between currently ascertained response delay time V1 and the end of currently ascertained switching time window SF are maintained, and currently ascertained response delay time V1 lies completely within currently ascertained switching time window SF. First specified safety time interval S1 makes possible a tolerance range between the beginning of the currently ascertained switching time window and the currently ascertained response delay time. Second specified safety time interval S2 makes possible a tolerance range between currently ascertained response delay time V1 and the end of currently ascertained switching time window SF. In this way, in response to a suitable selection of first specified safety time interval S1 and second specified safety time interval S2 it is ensured that the cutting off and cutting in again of gas-exchange valve 1 is able to take place without damage and without gas-exchange valve 1 getting stuck in the open position. First specified safety time interval S1 and second specified safety time interval S2 are suitably able to be applied on a test stand, for this purpose. In the process, first specified safety time interval S1 and second specified safety time interval S2 may be selected and applied while being of different magnitudes or the same magnitude. In the case of the selection of the first specified safety time interval S1 equal to the second specified safety time interval S2, currently ascertained response delay time V1 is able to be placed centrically at an equally large tolerance interval from the beginning of currently ascertained switching time window SF and from the end of currently ascertained switching time window, so that at both borders of currently ascertained switching time window SF an equal protective effect is achieved. If currently ascertained switching time window SF is greater than currently ascertained response delay time V1, inclusive of first specified safety time interval S1 and second specified safety time interval S2, currently ascertained response delay time V1 may also be positioned as desired, and not necessarily centrically in the currently ascertained switching time window, on the assumption that at least first specified safety time interval S1, between currently ascertained response delay time V1 and the beginning of currently ascertained switching time window SF, and at least second specified safety time interval S2 between currently ascertained response delay time V1 and the end of currently ascertained switching time window SF are maintained. Consequently, currently ascertained response delay time V1 does not necessarily lie centrically in currently ascertained switching time window SF.

For the case in which only first specified safety time interval S1 or only second specified safety time interval S2 are to be taken into consideration, and the currently ascertained switching time window is greater than currently ascertained response delay time V1 inclusive of first specified safety time interval S1 and inclusive of second specified safety time interval S2, currently ascertained response delay time V1 is also able to be situated in currently ascertained switching time window SF in such a way that the interval between the beginning of currently ascertained switching time window SF and currently ascertained response delay time V1 is greater than or equal to first specified safety time interval S1 or the interval between the end of currently ascertained switching time window SF and currently ascertained response delay time V1 is greater than or equal to second specified safety time interval S2.

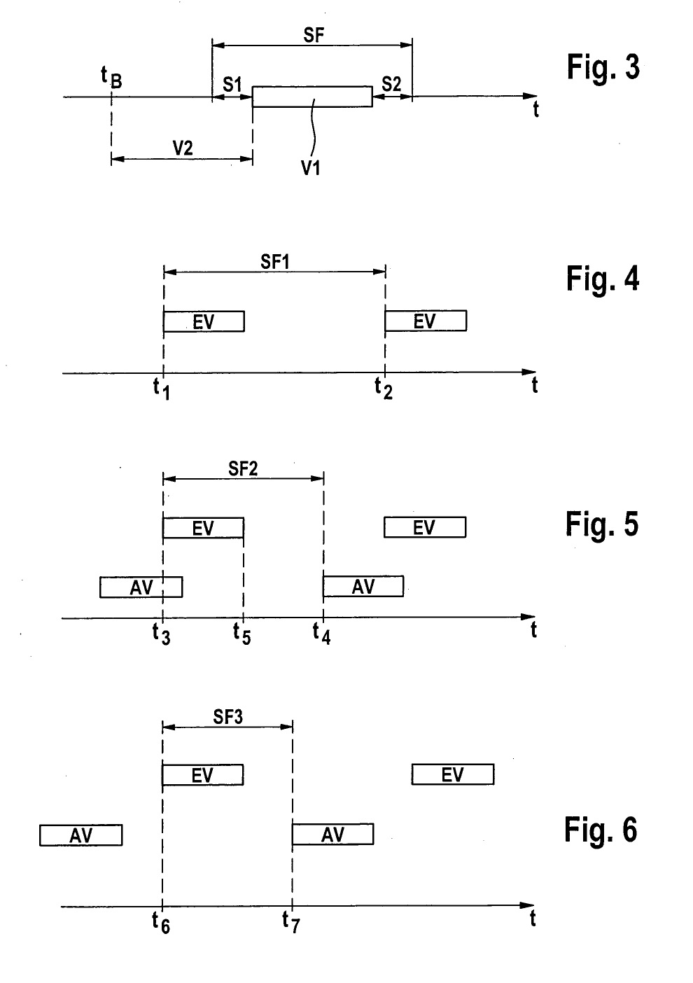

FIG. 3 shows a time line of an example in which the currently ascertained response delay time V1 together with first specified safety time interval S1 and second specified safety time interval S2 is exactly equivalent to currently ascertained switching time window SF. In this case, specification unit 40 places currently ascertained response delay time V1 into currently ascertained switching time window SF in such a way that the interval of currently ascertained response delay time V1, that is, the interval between the beginning of currently ascertained response delay time V1 and the beginning of currently ascertained switching time window SF is equivalent to first specified safety time interval S1, and that the interval of currently ascertained response delay time V1, that is, between the end of currently ascertained response delay time V1 and the end of currently ascertained switching time window SF is equivalent to second specified safety time interval S2. If S1 and S2 are selected to be the same size, optionally, currently ascertained response delay time V1 lies centrically in currently ascertained switching time window SF. Independently of how specified safety time interval S1, S2 were selected, specification unit 40 ascertains the point in time of the beginning of the switching procedure, and with that, the beginning of the electrical control of three-way valve 45 for cutting off or cutting in again gas-exchange valve 1, starting from the beginning of currently ascertained response delay time V1 that is situated in switching time window SF in the manner described, in that it subtracts from this currently ascertained response delay time V1 the currently ascertained time delay time V2, and thus arrives at point in time t_{B} for the beginning of the electrical control mentioned. Consequently, at point in time t_{B}, specification unit 40 causes the beginning of the electrical control of three-way valve 45 for cutting off or cutting in again gas-exchange valve 1. Instead of the point in time for the beginning of the switching procedure, specification unit 40 is also able to ascertain a crankshaft angle for the beginning of the switching procedure, the connection between the point in time and the assigned crankshaft angle being produced via the current engine speed.

FIGS. 4-6 show three different exemplary embodiments for ascertaining current switching time window SF. In the example shown in FIG. 4, it is assumed, for example, without the restriction of generality, that the gas-exchange valve is designed as an intake valve of the cylinder. In FIG. 4, the opening times of the intake valve are characterized by EV, in the form of rectangles plotted against a time line. Outside the rectangles, in the direction of the time axis, the intake valve is closed and camshaft 95 is located at its base circle. In FIG. 4, a first switching time window SF1 is now ascertained in such a way that it begins at the opening of the intake valve and ends at the next opening of the intake valve. As shown in FIG. 4, first switching time window SF! thus begins at a first point in time t₁ at the opening of the intake valve and ends at a second point in time t₂ at the next opening of the intake valve. Even if stud 10 is able to be moved only on the base circle of camshaft 95 for the decoupling or the coupling of first part 70 and second part 75, thus actually only outside the two opening phases of the intake valve shown in FIG. 4, the oil pressure required for the movement of stud 10 can nevertheless be set as soon as the opening of the intake valve has begun at first point in time t₁. The opening procedure of the intake valve is no longer impaired because it is outside the base circle of camshaft 95, where a motion of stud 10 is not possible. However, as soon as the base circle has been reached and the intake valve has been closed, the motion of stud 10 sets in and the currently ascertained response delay time V1 begins to run. For the decoupling of first part 70 and second part 75, in this context, a minimum specified oil pressure has to be exceeded, and for the recoupling of first part 70 and second part 75 a specified maximum oil pressure must not be exceeded, the minimum specified oil pressure and the maximum specified oil pressure being able to be suitably applied, for instance, on a test stand. The minimum specified oil pressure is greater than the maximum specified oil pressure, in this instance. If a cut-in gas-exchange valve is to be cut off, an oil pressure has to be set in store 90, starting from an oil pressure below the maximum specified oil pressure, which lies above the minimum specified oil pressure. Starting from the cut-off gas-exchange valve, if the gas-exchange valve is to be cut in again, then, starting from an oil pressure in store 90 above the minimum specified oil pressure, an oil pressure has to be set that is below the maximum specified oil pressure.

In FIG. 4, first switching time window SF1 and therewith also currently ascertained response delay time V1 are ended at the latest at the beginning of the next opening procedure of the intake valve, so that, in the case of an intake valve that is to be cut off, the intake valve is not unintentionally opened again, and in the case of an intake valve that is to be cut in again, the intake valve does not unintentionally remain closed. Switching time window ascertainment unit 30, for example, with the aid of the known camshaft adjustment, ascertains the time periods in which the intake valve is open according to FIG. 4. From these time periods first point in time t₁ may then be selected, in the manner described, as the beginning of first switching time window SF1, as the point in time at which the intake valve opens. Second point in time t₂ is then selected by switching time window ascertainment unit 30 in such a way that it corresponds to the beginning of the next opening of the intake valve. Instead of considering this with respect to a time range, one may also look at it with respect to a crankshaft angle range, the crankshaft angle, as described above, being connected via the engine speed of the internal combustion engine to the time, in a conventional manner.

A second exemplary embodiment for ascertaining a second switching time window SF2 is shown in FIG. 5. According to the second exemplary embodiment of FIG. 5, the assumption is made that the operating element of an intake valve of a cylinder of the internal combustion engine and the operating element of an exhaust valve of the same cylinder of the internal combustion engine are cut off or cut in again by a common coupling element 10, and that switching time window ascertainment unit 30 ascertains second switching time window SF2 in such a way that it begins in response to the opening of the intake valve and thus after the opening of the exhaust valve, and that it ends at the next opening of the exhaust valve, and thus before the next opening of the intake valve. In this context, the times are characterized in FIG. 5 at which the intake valve is open, in the same way as in FIG. 4, by rectangles marked EV, whereas times at which the exhaust valve is open are shown by rectangles designated as AV. As shown in FIG. 5, in this instance, there are times at which both the intake valve and the exhaust valve are open, that is, there is an overlap of the opening times of the intake valve and the exhaust valve. The same conditions apply for the establishment of the switching time window for the exhaust valve as described before, using FIG. 4 for the intake valve, since the exhaust valve, too, is cut off or cut in again if the assigned camshaft is on its base circle.

Switching time window ascertainment unit 30 first ascertains a fourth point in time t₄ as the end of second switching time window SF2, at which the exhaust valve opens again for the next time, but the intake valve is still closed. In this context, the opening time period of the exhaust valve lies before the opening time period of the intake valve, as is shown in FIG. 5. A third point in time t₃ for the beginning of second switching time window SF2 is then selected by switching time window ascertainment unit 30 in such a way that it lies at the beginning of the opening time of the intake valve, and thus after the beginning of the opening time of the exhaust valve, which directly precede fourth point in time t₄.

If, in reverse, the opening time period of the intake valve is before the opening time period of the exhaust valve, the end of second switching time window SF2 corresponds to the point in time at which the intake valve opens again the next time. The beginning of second switching time window SF2 then corresponds to the point in time at which the exhaust valve opens before.

The time period of second switching time window SF2 is available for the movement of common coupling element 10 for cutting off or cutting in again the intake valve or exhaust valve, in which both the intake valve and the exhaust valve are closed. This is the case between a fifth point t₅ and subsequent fourth point t₄, as shown in FIG. 5.

In the case of the cutting off of the intake valve and the exhaust valve in second switching time window SF2, the residual gas in the combustion chamber of the assigned cylinder is trapped, provided no additional valves than the intake valve and the exhaust valve of this cylinder shown in FIG. 5 are present and are open. Because of the entrapment of the residual gas in the combustion chamber of the cylinder, the cylinder is protected from cooling off, and when the cylinder is cut in again, this cylinder is still almost at operating temperature, so that no unfavorable combustion or unfavorable exhaust gas composition come about.

A third exemplary embodiment shown in FIG. 6 is implemented in the same way as the second exemplary embodiment of FIG. 5, the difference being that the opening time period of the intake valve and the opening time period of the exhaust valve do not overlap each other. This has the result that, according to the same rules as was described for FIG. 5, ascertained switching time window SF3 will be smaller, all other things being equal, than in the second exemplary embodiment as in FIG. 5. The reason is that, at a sixth point in time t₆, at which third switching time window SF3 begins, both the opening time of the intake valve and the opening time of the exhaust valve have already begun, but in the example as in FIG. 6, the opening time of the exhaust valve has already ended. Consequently, the time interval between the opening of the intake valve and the subsequent opening of the exhaust valve becomes shorter than in the exemplary embodiment as in FIG. 5, and thus it is that third switching time window SF3 is smaller than second switching time window SF2. At a seventh point in time t₇, which follows sixth point in time t₆, and at which neither the intake valve nor the exhaust valve is open, third switching time window SF3 has ended.

In FIGS. 5 and 6, the time axis is also able to be replaced by a crankshaft angle axis, the connection between crankshaft angle and time being produced in a manner known to one skilled in the art. Without a camshaft adjustment, in this context, on the time axis respective switching time window SF1, SF2, SF3 is smaller in time the greater the engine speed becomes. If the respective switching time window is smaller than is required for the currently ascertained response delay time V1 and the provided safety time intervals S1, S2, cutting off or cutting in again the corresponding gas-exchange valve is no longer possible, and thus also no longer a switchover from full engine operation to half engine operation or from half engine operation to full engine operation.

During the ascertainment of the respective switching time window, as was described, the current camshaft setting is taken into consideration, so that, in the case of different camshaft settings, different switching time windows also come about. The safety time interval S1, S2 should be applied in such a way that, because of the switching procedure of coupling element 10, neither damage to coupling element 10 nor damage to operating element 5 nor damage to the corresponding gas-exchange valve take place, or an undesired opening of a gas-exchange valve that is to be cut off, or an undesired closing of a gas-exchange valve that is to be cut in again are safely avoided, on the one hand and, on the other hand, as long as possible a response delay time can be accommodated in the currently ascertained switching time window.

If a cylinder has more than one intake valve or more than one exhaust valve, the above observations that were employed for an intake valve and an exhaust valve apply in the same manner to all the intake valves or the exhaust valves of the cylinder, as long as all the intake valves of the cylinder and all the exhaust valves of the cylinder are in each case controlled synchronously and have a common opening time period per power cycle. In this instance, it does not matter whether all intake valves or all exhaust valves are cut off or cut in again by a common coupling element. In this context, if a plurality of intake valves and a plurality of exhaust valves are cut off or cut in again by a common coupling element, this takes place in corresponding fashion, as was described for the second exemplary embodiment of FIG. 5 or for the third exemplary embodiment of FIG. 6.

The smaller or more negative the valve overlap of the opening time duration of the intake valve and the opening time duration of the exhaust valve of FIG. 5 or of FIG. 6 become, the smaller will be switching time window SF2 and SF3. Negative valve overlap means, in this instance, that there is no valve overlap, and it means the interval from the end of the opening time duration of the exhaust valve to the beginning of the subsequent opening time duration of the intake valve. If the valve overlap becomes more negative, this interval becomes larger.

What is claimed is:

1. A method for operating an internal combustion engine, comprising:
cutting off or cutting in again at least one intake valve or exhaust valve of a cylinder in at least one operating state, the at least one intake valve or exhaust valve being at least one of opened and closed using an operating element;
switching off or switching on again the operating element using a coupling element;
ascertaining a response delay time which is required for operation of the coupling element during the switching off or switching on again of the operating element;
ascertaining a switching time window within which the operation of the coupling element is desired;
checking whether the switching time window is greater than the response delay time; and
if the switching time window is greater than the response delay time, establishing a beginning of the switching procedure for cutting off or cutting in again the at least one intake valve or exhaust valve so that the response delay time lies completely within the switching time window.

2. The method as recited in claim 1, wherein the checking step includes checking whether the switching time window is greater than or equal to the response delay time inclusive of at least one safety time interval; and wherein the beginning of: i) the switching procedure is established so that at least one of a first specified safety time interval is maintained between the response delay time and a beginning of the switching time window, ii) and a second specified safety time interval is maintained between the response delay time and an end of the switching time window.

3. The method as recited in claim 2, wherein the first specified safety time interval and the second specified safety time interval are the same size.

4. The method as recited in claim 1, wherein a time delay time is ascertained which corresponds to a time duration from a beginning of an electrical control of the switching procedure up to a point in time of a setting in of the operation of the coupling element; and wherein the beginning of the switching procedure is established by the time delay time before a beginning of the response delay time.

5. The method as recited in claim 1, wherein the switching time window is ascertained so that it begins at an opening of the at least one intake valve or exhaust valve and ends at a next opening of the at least one intake valve or exhaust valve.

6. The method as recited in claim 1, wherein the operating element of at least one intake valve and the operating element of at least one exhaust valve are switched off or switched on again by a common coupling element; and wherein the switching time window is ascertained so that it begins after the opening of both the at least one intake valve and the at least one exhaust valve, and the switching time window ends before a next opening of both the at least one intake valve and the at least one exhaust valve.

7. A device for operating an internal combustion engine, comprising:
a switching device configured to, in at least one operating state, cut off at least one intake valve or exhaust valve of a cylinder or cut in again at least one cut-off intake valve or exhaust valve of the cylinder;
an operating element configured to at least one of open and close the at least one intake valve or exhaust valve;
a coupling element configured to switch off or switch on again the operating element;
a response delay time ascertainment device configured to ascertain a response delay time which is required for operation of the coupling element during the switching off or switching on again of the operating element;
a switching time ascertainment device configured to ascertain a switching time window within which operation of the coupling element is desired;
a checking device configured to check whether the switching time window is greater than the response delay time; and
an establishing device configured to establish a beginning of a switching procedure for cutting off or cutting in again the at least one intake valve or exhaust valve so that the response delay time lies completely within the switching time window.
